(19) United States
(12) Patent Application Publication
(10) Pub. No.: US 2009/0213741 A1
(43) Pub. Date: Aug. 27, 2009

(54) Multi-user MIMO systems with Imperfect CSIT and ARQ

(75) Inventors: Rui WANG, Hong Kong (CN); Vincent Kin Nang LAU, Hong Kong (CN)

Correspondence Address: TUROCY & WATSON, LLP, 127 Public Square, 57th Floor, Key Tower, CLEVELAND, OH, 44114, US

(73) Assignee: THE HONG KONG UNIVERSITY OF SCIENCE AND TECHNOLOGY, Hong Kong (CN)

(21) Appl. No.: 12/038,253

(22) Filed: Feb. 27, 2008

(51) Int. Cl. H04L 12/26

(52) U.S. Cl. 370/252

(57) ABSTRACT

A robust closed-loop cross-layer design provides for the downlink multi-user multi-antenna systems with imperfect Channel State Information at the transmitter (CSIT) for slow fading channels. Using ACK/NAK feedbacks from mobiles, a closed-loop cross-layer scheduler does not require any knowledge of the CSIT error statistics. To take into account of the potential packet outage (due to imperfect CSIT), we define system goodput, which measures the average bits per second per Hertz (b/s/Hz) successfully delivered to the mobiles, as the optimization objectives. We formulate the cross-layer design as a mixed combinatorial search and Markov decision problem. Based on dynamic programming approach, the optimal power and rate allocation is determined using backward recursion and forward recursion algorithms. Simulations illustrate that the proposed closed-loop cross-layer scheduler has very robust goodput performance at moderate to high CSIT errors and pedestrian mobility.

### TECHNICAL FIELD

The subject disclosure relates to cross-layer scheduling in multi-user multi-antenna system, but more specifically to such scheduling with incomplete channel state information and/or incomplete automatic repeat-request (ARQ) communication.

### BACKGROUND

Recently, cross-layer scheduling in multi-user multi-antenna system has received tremendous attention. High spectral efficiency can be achieved by exploiting multi-user selection diversity and spatial multiplexing. To exploit the multi-user selection diversity, knowledge of Channel State Information (CSI) is required at the base station. However, obtaining perfect Channel State Information at the Transmitter (CSIT) is very challenging at the base station especially for large number of transmit antennas n_{T} or large number of users K.

It should be appreciated that there are two interpretations of imperfect CSIT in the literature. The first meaning refers to the incomplete knowledge of CSIT such as the partial CSIT or limited feedback of CSIT. Yet, the incomplete CSIT is received error-free and without delay and hence, there is no issue of packet outage. The second meaning refers to the “erroneous CSIT” in which the CSIT obtained has errors or suffer from delay (no longer updated). In this case, there will be uncertainty on the instantaneous mutual information and hence, issues of packet outage. In the disclosure that follows, one focus is on the second meaning behind imperfect CSIT.

When we have imperfect CSIT at the base station, the actual instantaneous mutual information is unknown to the base station and as a result, the scheduled data rate may be larger than the instantaneous channel capacity (which is unknown to the transmitter). This results in packet transmission outage which will occur even if powerful error correction code is applied. Moreover, the efficiency of the multi-user scheduling is reduced because the wrong set of users may be selected for transmission. Most of the existing cross-layer designs addressed the imperfect CSIT issue based on heuristic approach. For example, in one approach the cross-layer scheduler is designed assuming CSIT is perfect and the effect of imperfect CSIT is evaluated by simulations. However, this approach does not offer any design insight on what should be the optimal design and performance with imperfect CSIT as the optimal design can be quite different from that with perfect CSIT. It is also found that the performance of the naive cross-layer scheduler (designed as if the CSIT were perfect) is very sensitive to imperfect CSIT even at very small CSIT errors. It has also been considered that the MMSE transmitter design with imperfect channel state information at the receiver (CSIR) and perfect CSI feedback channel. Another approach is optimal resource allocation for multi-antenna systems with imperfect CSIT. Optimal cross-layer design for multi-user systems with imperfect CSIT has been contemplated. However, in all these conventional approaches, the base station requires knowledge of CSIT error statistics (such as error variance and the CSIT error statistics), which may not be easily available in practice as well. In all the generally known approaches, the cross-layer design is open loop. In open-loop designs, the power, rate and user adaptation are determined based on a particular CSIT error statistics. If there is mismatch on the assumed parameters (e.g. CSIT error variance) versus the actual parameters, the open-loop design will not be able to automatically correct for those and therefore, the performance will be sensitive to the mismatch of the CSIT error model. There are some existing works using the closed-loop adaptation design with the ACK/NAK feedbacks. For example, a power and rate control policy for a point-to-point SISO system with delay constrained traffic based on ACK/NAK feedback has been presented. However, the cross-layer scheduling (user selection) issue is not addressed and the power and rate adaptation policy cannot be extended to MIMO situations. A heuristic adaptive rate control and randomized scheduling algorithm for flat-fading SISO channels based on learning automata has also been presented. In all these instances, the solutions are heuristic and it is not clear what should be the optimal policy and how far the schemes are from optimal performance. Furthermore, the solution cannot be applied to MIMO systems and these policies cannot guarantee a target frame error rate (FER) for wireless links, which is a very important requirement from applications.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In accordance with one or more aspects and corresponding disclosure thereof, various aspects are described in connection with a methodology for closed-loop downlink cross-layer scheduling in a multiple-input single output system in a slow fading channel with imperfect channel state information at the transmitter (CSIT). Rate of acknowledgements and nonacknowledgements (ACK/NAK) from a mobile terminal are measured in order to estimate CSIT. Power and rate allocation are optimized on a downlink to the mobile terminal as a mixed combinatorial search and Markov decision process. Thus, an optimum solution is achieved that asymptotically optimal for small target frame rate without confronting an overly complex computation or the incomplete solution using conventional open-loop approaches.

In another aspect, an apparatus is provided for closed-loop downlink cross-layer scheduling in a multiple-input single output system. A receiver at a base station measures rate of acknowledgements and nonacknowledgements (ACK/NAK) from a mobile terminal in a slow fading channel. A processor estimates channel state information at transmitter (CSIT) based upon the measured rate of ACK/NAK for closed loop power and rate control. A scheduler optimizes power and rate allocation on a downlink to the mobile terminal as a mixed combinatorial search and Markov decision process.

In an additional aspect, an apparatus for closed-loop downlink cross-layer scheduling in a multiple-input single output system has means for measuring rate of acknowledgements and nonacknowledgements (ACK/NAK) from a mobile terminal in a slow fading channel. In addition, means is provided for estimating channel state information at transmitter (CSIT) based upon the measured rate of ACK/NAK. Furthermore, means are provided for optimizing power and rate allocation on a downlink to the mobile terminal as a mixed combinatorial search and Markov decision process.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

FIG. 1 depicts a methodology for optimizing power and rate allocation for multiple-user communication system that overcomes a flat fading multiple-input single output (MISO) communication channel.

FIG. 2 depicts a MISO system that overcomes a flat fading multiple-input single output (MISO) communication channel.

FIG. 3 depicts a block diagram structure of scheduling slot and packet slot.

FIG. 4 depicts a block diagram of zero-forcing (ZF) processing at a base station in multi-user multiple-input single output (MISO) systems.

FIG. 5 depicts a timing diagram of outputs of a closed-loop scheduler.

FIG. 6 depicts a flow diagram of a methodology for backward recursion.

FIG. 7 depicts a flow diagram of a methodology for forward recursion.

FIG. 8 depicts a plot of average goodput performance of a closed-loop scheduler for a Doppler frequency of 1 Hz.

FIG. 9 depicts a plot of average goodput performance of a closed-loop scheduler for Doppler frequency of 10 Hz.

FIG. 10 depicts a plot of average goodput and the average capacity per packet slot versus the packet time slot number for a Doppler frequency of 1 Hz.

FIG. 11 depicts a plot of average goodput and the average capacity per packet slot versus the packet time slot number for Doppler frequency of 10 Hz.

FIG. 12 depicts a plot of transient of instantaneous scheduled data rate versus actual instantaneous channel capacity of each packet burst.

FIG. 13 depicts a block diagram of a network environment suitable for service by embodiments of the innovation.

FIG. 14 depicts a block diagram representing an exemplary non-limiting computing system or operating environment in which the present innovation can be implemented.

### DETAILED DESCRIPTION

### 1. Introduction

Cross-layer designs for multi-antenna multi-user systems have been shown to offer significant gains of spectral efficiency by exploiting multiuser diversity and spatial multiplexing. However, in most existing designs, perfect knowledge of channel state information at the transmitter (CSIT) is assumed. In practice, perfect knowledge of CSIT is not easy to achieve especially for large number of users or antennas. When we have imperfect CSIT at the transmitter, there may be packet transmission outage and it is a tricky problem for cross-layer design with imperfect CSIT. There are some latest designs that take the CSIT errors into the cross-layer design. However, in these works (open-loop approach), the knowledge of CSIT statistics (such as error variance and distribution of the CSIT errors) is required, which may be difficult to obtain as well. A novel closed-loop approach described herein addresses a need for robust cross-layer design of downlink multi-user multi-antenna systems with imperfect channel state information at the transmitter (CSIT) in slow fading channels. Based on the ACK/NAK feedbacks from the mobiles, the cross-layer design does not require knowledge of the CSIT error statistics. To take into account of the potential packet outage due to the imperfect CSIT, we shall define average system goodput, which measures the average bits per second per Hertz (b/s/Hz) successfully delivered to the mobile terminal, as our optimization objective. We formulate the cross-layer design as a mixed combinatorial search and Markov decision process (MDP). While general solutions for MDP are very complex, one aspect described herein is that we obtain simple closed-form power, rate and user allocation policy that is asymptotically optimal for small target frame error rate (FER). Simulation results illustrate that the performance of the closed-loop cross-layer design is very robust with respect to imperfect CSIT, model mismatch as well as channel variations due to Doppler.

In addressing a novel robust closed-loop cross-layer design for the downlink multi-user multi-antenna systems with imperfect CSIT in slow fading channels, ACK/NAK feedbacks from the mobile terminals is used to adjust the power allocation, rate allocation and user selection in a scheduling time slot so as to maintain a target FER. No knowledge of the CSIT error statistics is required at the base station and the performance of the closed-loop design is very robust with respect to CSIT errors. To take into account of the potential packet outage, we define system goodput, which measures the average b/s/Hz successfully delivered to the mobiles, as the optimization objective. By formulating the cross-layer design as a mixed combinatorial search and Markov decision process (MDP), we are able to discuss the optimal control policy as well as the optimal performance. It is well-known that there is no simple solution in general for MDP problems and the solution will have very high complexity. As a result, all the existing works on closed-loop adaptation are based on heuristic designs only. One aspect described herein is that a simple closed-form power and rate allocation solutions for the MDP problem that is optimal for sufficiently small target FER. This substantially simplified the implementation complexity of the proposed scheme. Finally, simulation results illustrate that the goodput performance of the closed-loop cross-layer design is very robust with respect to imperfect CSIT, model mismatch as well as channel variation due to Doppler.

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

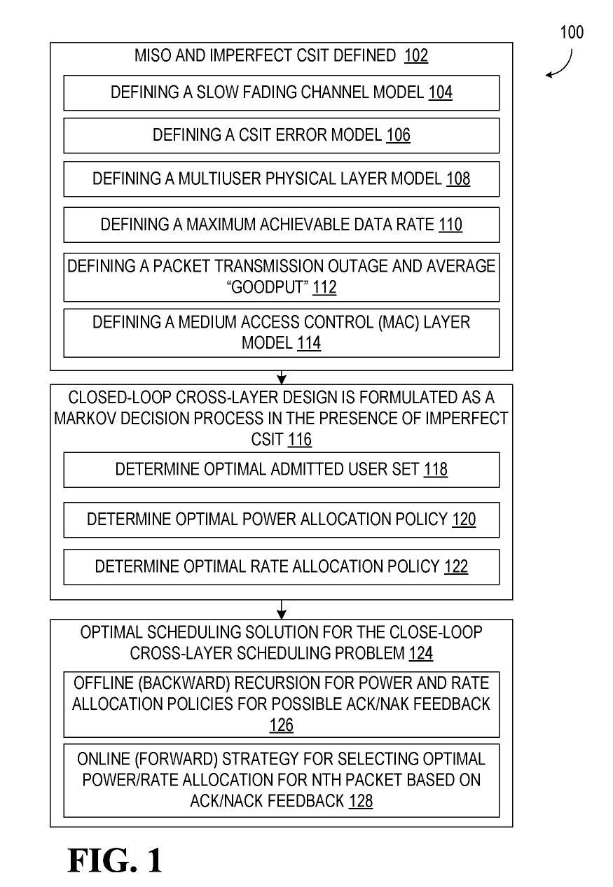

With reference to FIG. 1, as an overview of a methodology 100 to be described in sections to follow, in section 2, a multi-user multiple-input single output (MISO) system model as well as an imperfect CSIT model are defined and discussed, as depicted at 102. Contributing to this development are defining a slow fading channel model in section 2.1 depicted at 104, defining a CSIT error model in section 2.2 depicted at 106, defining a multiuser physical layer model in section 2.3 depicted at 108, defining a maximum achievable data rate in section 2.4 depicted at 110, defining a packet transmission outage and average “goodput” in section 2.5 depicted at 112, and a medium access control (MAC) layer model in section 2.6 depicted at 114. In section 3, a closed-loop cross-layer design is formulated as a Markov decision process in the presence of imperfect CSIT as depicted at 116. Contributing to this formulation are determining an optimal admitted set of users depicted at 118, determining an optimal power allocation policy depicted at 120, and determining an optimal rate allocation policy at 122. In section 4, the optimal solution for the close-loop cross-layer scheduling problem is presented as depicted at 124. Supporting this solution, recognition of that an offline (backward) recursion can be used to optimize power and rate allocation for possible ACK/NAK feedback as depicted at 126. Then, an online (forward) strategy can be employed to select a corresponding set of values for a next (n^{th}) packet based upon ACK/NAK feedback as depicted at 128 In section 5, numerical results are presented and discussed, illustrating benefits of the afore-mentioned methodology 100.

### 2. Multi-User MISO System Model

An information theoretical approach in system modeling is adopted herein, hence, the performance of the physical layer is decoupled from any specific channel coding and modulation scheme. Furthermore, to decouple the data sources statistics from the system performance, we assume the data sources are delay insensitive and the buffers are large in size so that they always contain source packets waiting to be transmitted. In other words, there will be no empty scheduling slots due to insufficient source packets at the buffers. In the following, we shall first describe the slow fading channel model, followed by the CSIT error model, the multi-user physical layer model as well as the MAC layer model.

### 2.1. Slow Fading Channel Model.

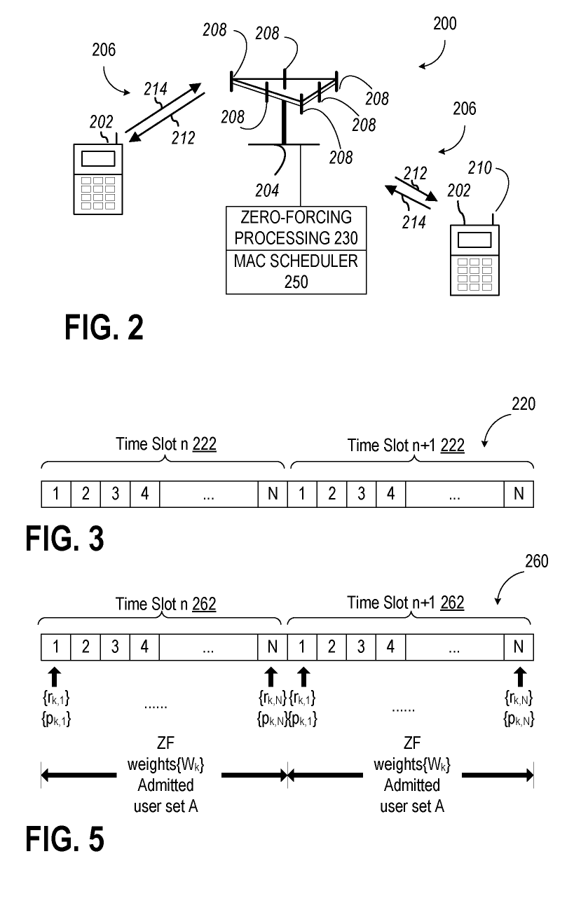

With reference to FIG. 2, we consider a communication system 200 with K mobile terminals 202 for users and one base station 204 over a slow-varying flat fading channel 206. We assume the base station 204 is equipped with n_{T} transmit antennas 208 and each mobile user is equipped with only one receive antenna 210. We shall assume the fading between antennas at the base station are uncorrelated. In fact, it is a realistic assumption for uncorrelated fading at the base station because we can generally afford a larger antenna spacing at the base station 204. For instance, if we consider a dense scattering environment with wide angle spread and a carrier frequency of 5 GHz. At the base station 204, the coherence distance for antenna correlation coefficient of 0.1 is around 10λ that is around 0.5 m. Hence, the uncorrelated antenna assumption at the base station can be justified within practical implementation limits.

To isolate the physical layer from the implementation details such as coding and modulation schemes, we use information theoretical approach to evaluate the data rate of the physical layer. The maximum achievable data rate refers to Shannon's capacity that is based on random coding book, Gaussian constellation, and maximum likelihood decoding at the receivers. In fact, using turbo coding or low density parity check (LDPC) coding, the Shannon's capacity can be approached to within 0.05 dB limit.

For simplicity, we assume the delay of the ACK/NAK is small compared with the packet duration.

We consider a scheduling slot structure 220, which consists of multiple packet bursts 222 as illustrated in FIG. 3. Our system 200 is targeted at low mobility users (e.g. pedestrian users with mobility less than 5 km/hr) and therefore, the coherence time for 90% correlation is around 4 ms at f_{c}=2.4 GHz. Since the channel fading remains quasi-static within a duration of 4 ms, we assume the channel is quasi-statistic within a scheduling slot as described herein.

Let Y_{k,n} be the received signal at the k-th mobile in the n-th packet burst in a scheduling slot. The K×1 dimension vector of the aggregate received signals Yₙ in the n-th packet burst is given by:

$${Y}_{n} = [ \begin{matrix}{Y}_{1 , n} \\ ⋮ \\ {Y}_{K , n}\end{matrix} ] = [ \begin{matrix}{H}_{1} \\ ⋮ \\ {H}_{K}\end{matrix} ] {X}_{n} + [ \begin{matrix}{Z}_{1 , n} \\ ⋮ \\ {Z}_{K , n}\end{matrix} ] \qquad ( 1 )$$

where Xₙ is the n_{T}×1 transmit symbol from the base station to the K mobiles, Hₖ is the 1×n_{T} channel coefficients where each element is independent and identically-distributed (i.i.d.) complex Gaussian with zero mean and unit variance, Z_{k,n} is the i.i.d. complex Gaussian noise with variance σ_{z}².

### 2.2. CSIT Error Model.

With further reference to FIG. 2, in practice, a downlink pilot channel 212 (from the base station 204) is usually allocated large power because it can be shared by the K users of the mobile terminals 202. Hence, the CSI estimation at the mobile terminals 202 (CSIR) can be quite accurate and for simplicity, we assume the CSIR at the mobile terminal 202 is perfect. On the other hand, obtaining perfect CSIT is very challenging at the base station 204. For example, if time division duplex (TDD) system is considered, the base station 204 estimates the CSIT based on the dedicated uplink pilots 214 from the K users. Since the uplink pilots 214 are dedicated pilots per user and cannot be shared, the power allocated in the uplink pilots 214 are usually smaller and the CSIT obtained at the base station 214 is likely to be imperfect. On the other hand, in the frequency division duplex (FDD) systems, the CSIT is obtained by CSI feedback from mobile terminals 202 to the base station 204. However, only a small number of bits is allocated for CSI feedback in practice and hence, the CSIT quality is also imperfect. In any case, the imperfect CSIT at the base station 204 can be modeled as:

Hₖ^{b}=Hₖ+ΔHₖ^{b} (2)

where Hₖ is the actual CSI and ΔHₖ^{b} is the CSIT estimation error matrix. In some existing cross-layer designs to address imperfect CSIT issues, the base station is assumed to have the knowledge of the CSIT error distribution as well as the error variance σ_{ΔH}². However, even these information about the CSIT error ΔHₖ^{b} is difficult to obtain in practice. It should be appreciated with the benefit of the present disclosure that a robust closed-loop cross-layer design is described where no knowledge of the CSIT error statistics is needed.

### 2.3. Multiuser Physical Layer Model.

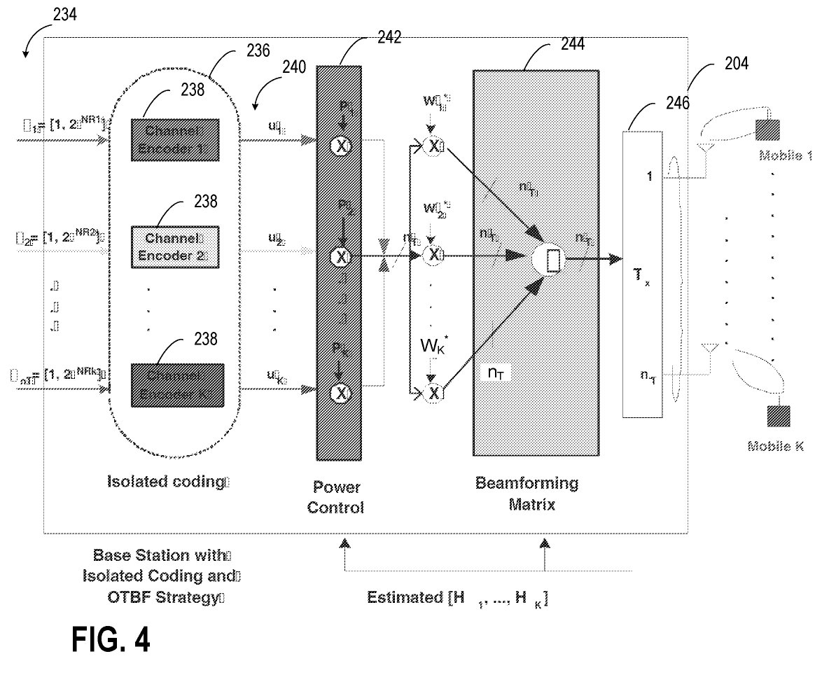

While the optimal multi-user downlink processing at the base station 204 is based on dirty paper coding, the implementation complexity is enormous and is not practical. We shall consider a simple zero-forcing (ZF) processing 230 at the base station 204 for practical consideration. FIG. 4 illustrates the ZF processing 230. At the base station 204, the K streams 234 of information data for the K individual users of K mobile terminals 202 (some users may be assigned zero rate if not selected by the scheduler) are channel encoded as depicted at 236 independently at the base station 204 by separate channel encoders 238.

During the n-th packet burst, a K×1 vector of encoded symbols 240, Uₙ=[U_{1,n}, . . . ,U_{K,n}]^{T}, are further processed by a K×K diagonal power control matrix 242 Pₙ=diag(p_{1,n}, . . . ,p_{k,n}, . . . ,p_{K,n}) and an n_{T}×K spatial multiplexing matrix 244 W=[w₁, . . . ,wₖ, . . . ,w_{K}], where p_{k,n}≧0 is a transmit power for a transmitter 246 and wₖ is the n_{T}×1 complex spatial multiplexing weight for the k-th user. In the n-th packet burst, the received signal of the k-th user Y_{k,n} is given by:

$${Y}_{k , n} = \underbrace{\sqrt{{p}_{k , n}} {H}_{k} {w}_{k} {U}_{k , n}}_{Information} + \underbrace{{\sum }_{j \neq k} \sqrt{{p}_{j , n}} {H}_{k}^{b} {w}_{j} {U}_{j , n}}_{Multiuser Interference I} - \underbrace{{\sum }_{j \neq k} \sqrt{{p}_{j , n}} Δ {H}_{k}^{b} {w}_{j} {U}_{j , n}}_{Multiuser Interference II} + {Z}_{k , n} \qquad ( 3 )$$

where Hₖ^{b} denotes the estimated CSIT, the first term contains the desired signal and the second term represents the multiuser interference I due to simultaneous transmission of independent information streams for different users and the third term represent the multiuser interference II due to CSIT error. Since the base station 204 only has the knowledge of the estimated CSIT H^{b}={H₁^{b}, . . . ,H_{K}^{b}}, the spatial multiplexing weights cannot be chosen to eliminate completely both multiuser interference terms in Eqn. (3). Using the zero-forcing (ZF) approach, the spatial multiplexing weight wₖ is selected to satisfy the normalized conditions

wₖ*wₖ=1

and the orthogonality conditions

Hⱼ^{b}wₖ=0∀jε A, j≠k

where A is the set of admitted user indices (users with non-zero allocated power and rate) and the operator * denotes complex conjugate transpose. With the ZF approach, the multiuser interference I is zero-out. Due to the limitation of the zero-forcing processing, we have |A|<n_{T}, thus, the transmitter can select at most n_{T} users simultaneously for each packet slot. In physical layer, the spatial multiplexing weights {wₖ} are calculated at the beginning of a scheduling slot based on the imperfect CSIT and keep unchanged during the entire scheduling slot.

### 2.4. Maximum Achievable Data Rate.

To isolate the physical layer from the implementation details such as coding and modulation schemes, we use information theoretical approach to evaluate the data rate of the physical layer. The maximum achievable data rate refers to Shannon's capacity that is based on random coding book, Gaussian constellation, and maximum likelihood decoding at the receivers. In fact, using turbo coding or LDPC coding, the Shannon's capacity can be approached to within 0.05 dB limit.

For simplicity, the delay of the ACK/NAK is small compared with the packet duration is assumed.

The maximum achievable data rate of the k-th user in the n-th packet burst is given by the maximum mutual information between Y_{k,n} and U_{k,n} conditional on CSIR Hₖ:

$$\begin{matrix}{C}_{k , n} = {max}_{P ( {U}_{k , n} )} I ( {U}_{k , n} ; {Y}_{k , n} \vert {H}_{k} ) \\ = {log}_{2} ( 1 + \frac{{p}_{k , n} {\vert {H}_{k} {w}_{k} \vert}^{2}}{{σ}_{z}^{2} + {\sum }_{j \neq k} {p}_{j , n} {\vert Δ {H}_{k} {w}_{j} \vert}^{2}} )\end{matrix} \qquad ( 4 )$$

where I(X,Y) denotes the conditional mutual information. Note that C_{k,n} is a function of Hₖ and ΔHₖ which are unknown to the base station.

### 2.5. Packet Transmission Outage and Average Goodput.

From Eqn. (4), given any estimated CSIT H^{b}, there is still uncertainty on the channel capacity C_{k,n} and packet transmission outage is possible when the scheduled data rate r_{k,n} exceeds the actual capacity C_{k,n}. When this happens, the transmit packet will be corrupted and packet outage occurs despite the use of powerful error correction codes. To take into account of the possibility of packet transmission outage in the system, we define system goodput, which measures the b/s/Hz successfully delivered to the users, below.

Let r_{k,n} be the scheduled data rate for the user k in the n-th packet. The instantaneous goodput of the k-th user in the n-th subcarrier is given by:

ρ_{k,n}=r_{k,n}1[C_{k,n}≧r_{k,n}] (5)

where 1(E) is the indicator function which is equal to 1 if the event E is true and 0 otherwise. The average total goodput, which measures the average total b/s/Hz successfully delivered to the mobiles (averaged over ergodic realization of CSI), is defined as:

$$\begin{matrix}U ( {P}_{0} , A , \{ {r}_{k , n} \} , \{ {p}_{k , n} \} ) = E [ {\sum }_{n = 1}^{N} {\sum }_{k = 1}^{K} {ρ}_{k , n} ] \\ = {E}_{{H}^{b}} \{ {\sum }_{n = 1}^{N} {\sum }_{k = 1}^{K} {E}_{H \vert {H}^{b}} [ {r}_{k , n} 1 [ {C}_{k , n} \geq {r}_{k , n} ] \vert {H}^{b} ] \} \\ = {E}_{{H}^{b}} \{ {\sum }_{n = 1}^{N} {\sum }_{k = 1}^{K} {r}_{k , n} Pr [ {C}_{k , n} \geq {r}_{k , n} \vert {H}^{b} ] \} \\ = {E}_{{H}^{b}} \{ G ( {P}_{0} , {H}^{b} , A , \{ {r}_{k , n} \} , \{ {p}_{k , n} \} ) \}\end{matrix} \qquad ( 6 )$$

where E_{H}_{^{b}}[X] denotes the expectation of the random variable X with respect to (w.r.t.) H^{b}, P₀,A,{r_{k,n}},{p_{k,n}} denote the total transmit power constraint, the user selection policy, the rate allocation policy and the power allocation policy, respectively and G(P₀,H^{b},A,{r_{k,n}},{p_{k,n}}) denotes the conditional system goodput (conditioned on the CSIT H^{b}). Due to the imperfect CSIT and the associated packet outage, we shall design the cross-layer scheduler to optimize the total average system goodput.

### 2.6. MAC Layer Model.

The MAC layer is responsible for scheduling the channel resource at each scheduling slot based on the physical layer model we described above. At the beginning of a scheduling slot, the base station 204 obtains the imperfect CSIT of all the K users and pass CSIT to a scheduler 250 in MAC layer. The output of the scheduler consists of the admitted user set A, the power and rate allocation of the selected users for a first packet {p_{k,1}}, {r_{k,1}} 260 as illustrated in FIG. 5. After the packets 262 in the first packet slot is transmitted, the selected mobile terminals will send the ACK/NAK indication to the base station before the next packet is delivered. For simplicity, we assume the delay of the ACK/NAK is small compared with the packet duration. For subsequent packet slots in a scheduling slot, the cross-layer scheduler 250 (FIG. 4) adapts the power allocation and rate allocation {p_{k,n}}, {r_{k,n}} for n>1 based on the CSIT and the ACK/NAK feedbacks from the mobiles as illustrated in FIG. 5.

### 3. Cross-Layer Design Formulation With Imperfect CSIT

In this section, we shall formulate the closed-loop cross-layer scheduling as a Markov decision problem. To take into consideration of the potential packet outage given any realization of the imperfect CSIT, we optimize the conditional average system goodput G(P₀,H^{b},A,{r_{k,n}},{p_{k,n}}) in Eqn. (6). For notation convenience, we define q_{k,i}={0,1} as the ACK/NAK feedback from mobile user k after the i-th packet transmission. q_{k,i}=1 if an ACK is received and 0 otherwise. Let Sᵢ={q_{k,i}:∀k ε A} denote the collection of all the ACK/NAK feedbacks from the selected users after the i-th packet transmissions and Sᵢ^{N}=(Sᵢ, . . . ,S_{N}). The conditional goodput G(P₀,H^{b},A,{r_{k,n}},{p_{k,n}}) in Eqn. (6) can be expressed as:

$$\begin{matrix}G ( {P}_{0} , {H}^{b} , A , \{ {r}_{k , n} \} , \{ {p}_{k , n} \} ) = {\sum }_{n = 1}^{N} {\sum }_{k = 1}^{K} {E}_{H \vert {H}^{b}} [ {r}_{k , n} 1 [ {C}_{k , n} \geq {r}_{k , n} ] \vert {H}^{b} ] \\ = {E}_{{S}_{1}^{N}} \{ {\sum }_{n = 1}^{N} {\sum }_{k = 1}^{K} {E}_{H} [ {r}_{k , n} 1 [ {C}_{k , n} \geq \\ {r}_{k , n} ] \vert {H}^{b} , {S}_{1}^{N} ] \} \\ = {E}_{{S}_{1}^{N}} \{ {\sum }_{n = 1}^{N} {\sum }_{k = 1}^{K} {r}_{k , n} Pr [ {C}_{k , n} \geq \\ {r}_{k , n} \vert {H}^{b} , {S}_{1}^{n - 1} ] \} \\ = {E}_{{S}_{1}^{N}} \{ {\sum }_{n = 1}^{N} {\overline{g}}_{n} \}\end{matrix} \qquad ( 7 )$$

where g̅ₙ denotes the conditional average goodput (conditioned on the CSIT H^{b} and the ACK/NAK feedback sequence S₁ⁿ⁻¹) and is given by:

$${\overline{g}}_{n} ( A , \{ {p}_{k , n} \} , \{ {r}_{k , n} \} , {H}^{b} , {S}_{1}^{n - 1} ) = {\sum }_{k = 1}^{K} {r}_{k , n} Pr [ {C}_{k , n} \geq {r}_{k , n} \vert {H}^{b} , {S}_{1}^{n - 1} ] \qquad ( 8 )$$

Since the admitted user set A is a function of CSIT and the rate and power allocation are functions of CSIT and ACK/NAK feedbacks, the closed-loop cross-layer scheduling problem with imperfect CSIT can be summarize as the following optimization problem:
Problem 1. Cross-Layer Problem Formulation with Imperfect CSIT Given any realization of the estimated CSIT for all mobile users {H₁^{b}, . . . ,H_{K}^{b}}, determine the optimal admitted user set A, the optimal power allocation policy {p_{k,n}} and the optimal rate allocation policy {r_{k,n}} to maximize the conditional total goodput, G(P₀,H^{b},A,{r_{k,n}},{p_{k,n}}). That is,

$${G}^{*} ( {P}_{0} , {H}^{b} , A , \{ {r}_{k , n} \} , \{ {p}_{k , n} \} ) {max}_{\{ {p}_{k , n} \} , \{ {r}_{k , n} \} , A} {E}_{{S}_{1}^{N}} \{ {\sum }_{n = 1}^{N} {\overline{g}}_{n} \} \qquad ( 9 )$$

where the power allocation, rate allocation policies {r_{k,n}},{p_{k,n}}) is subject to the following constraints:
Causality Constraint: The power and rate allocation should be a causal function of the ACK/NAK feedbacks Sₙ. i.e. p_{k,n}=p_{k,n}(S₁ⁿ⁻¹) and r_{k,n}=r_{k,n}(S₁ⁿ⁻¹).
Total Transmit Power Constraint:

$${\sum }_{n = 1}^{N} {\sum }_{k ∈ A} {p}_{k , n} \leq {P}_{0}$$

Cardinality Constraint:

|A|≦n_{T}
Quality of Service (QoS) Requirement: The conditional packet outage probability of the users is less than a target outage probability ε.

The optimization variables in the Problem posed by Eqn. (9) include combinatorial variables (A) as well as real variables ({p_{k,n}}, {r_{k,n}}) and hence, it is a mixed convex and combinatorial optimization problem. To solve the mixed combinatorial and convex optimization problem, we shall separate the solution into two steps. In the first step, we shall determine the optimal power and rate allocations based on a given admitted user set A. In the second step, a combinatorial search is performed over all combinations of A to determine the optimal set. These two steps are elaborated in the following sections.

4. Closed-Loop Cross-Layer Scheduling Solution for {p_{k,n}} and {r_{k,n}}

Given an admitted user set A, we shall determine the optimal power allocation scheme {p_{k,n}} and the optimal rate allocation scheme {r_{k,n}} based on the imperfect CSIT and the ACK/NAK feedbacks from the mobiles terminals 202 (FIG. 2). To obtain more insight into the structure of the optimization problem, we shall show that the optimal objective G*(P₀,H^{b},A) can be divide and conquer into a set of recursive equations. In this section, we shall derive the recursive relationship first, and then, solve the convex optimization problem based on this recursive structure.

The optimal conditional average goodput G*(P₀,H^{b},A) in Eqn. (9) can be expressed into a recursive form as summarized by the following lemma.
Lemma 1. Recursive Formulation of the Conditional Goodput Let Fₙ*(P,H^{b},S₁ⁿ⁻¹) be the total optimal average goodput from the n-th packet burst to the N-th packet burst conditional on the CSIT and the first n−1 ACK/NAK feedbacks i.e.,

$${F}_{n}^{*} ( P , {H}^{b} , {S}_{1}^{n - 1} ) = {max}_{\{ {p}_{k , n} , … , {p}_{k , N} \} , \{ {r}_{k , n} , … , {r}_{k , N} \} } \{ {\overline{g}}_{n} ( \{ {p}_{k , n} \} , \{ {r}_{k , n} \} , {H}^{b} , {S}_{1}^{n - 1} ) + {\sum }_{{S}_{n}} Pr ( {S}_{n} \vert {S}_{1}^{n - 1} ) {\overline{g}}_{n + 1} ( \{ {p}_{k , n + 1} \} , \{ {r}_{k , n + 1} \} , {H}^{b} , {S}_{1}^{n} ) + {\sum }_{{S}_{n}^{N}} Pr ( {S}_{n}^{N} \vert {S}_{1}^{n - 1} ) {\overline{g}}_{N} ( \{ {p}_{k , N} \} , \{ {r}_{k , N} \} , {H}^{b} , {S}_{1}^{N - 1} ) \} \qquad ( 10 )$$

where the transmit power constraint is given by

$${\sum }_{i = n}^{N} {\sum }_{k ∈ A} {p}_{k , n} = P \qquad ( 11 )$$

and g̅ᵢ is given in (8). Fₙ*(P,H^{b},S₁ⁿ⁻¹) can be expressed recursively as:

$${F}_{n}^{*} ( P , {H}^{b} , {S}_{1}^{n - 1} ) = {max}_{\{ {p}_{k , n} \} , \{ {r}_{k , n} \}} \{ \begin{matrix}{\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) {F}_{n + 1}^{*} ( P - {p}_{n} , {H}^{b} , {S}_{1}^{n} )\end{matrix} \} \\ where \\ {p}_{n} = {\sum }_{k ∈ A} {p}_{k , n} \qquad ( 12 )$$

for all n ε [1,N] and F_{N+1}*=0. The optimal conditional goodput in (9) is given by

G*(P₀,H^{b},A)=F₁*(P₀,H^{b}) (13)

The proof for Lemma 1 is given below.

As a result of Lemma 1, Eqn. (13), the optimization problem with respect to {r_{k,n}},{p_{k,n}} (given any CSIT realization H^{b}) can be divided and conquer into N steps. The recursive equation in Eqn. (12) is also called the Bellmen's equation and the optimization problem belongs to the Markov decision problem. The general solution of the Markov decision problem involves an offline recursion and an online strategy. The offline recursion is to determine the power allocation and rate allocation policies for all possible ACK/NAK feedbacks. In the illustrative version, this is not a real-time process. On the other hand, the online strategy is a real-time algorithm that selects the optimal power and rate allocation for the n-th packet burst upon receiving the previous ACK/NAK feedbacks from the mobile terminals 202. We shall elaborate the offline and online solutions in the following sections.

### 4.1. General Backward Recursion for the Rate and Power Adaptation Policies.

In the offline strategy, we shall partition the optimization for the average goodput G*(P,H^{b}) with respect to the power allocation policy {p_{k,1}},{p_{k,2}}, . . . ,{p_{k,N}} and the rate allocation policy {r_{k,1}},{r_{k,2}}, . . . ,{r_{k,N}} (for the N packet bursts) into N recursive optimizations using the recursive relationship of Fₙ* and Fₙ₊₁* in (12). Let {r_{k,n}*},{p_{k,n}*} be the optimized rate and power allocation policies with respect to all possible ACK/NAK feedback events. These optimal policies will be used for the online algorithm when the actual ACK/NAK feedbacks are received.

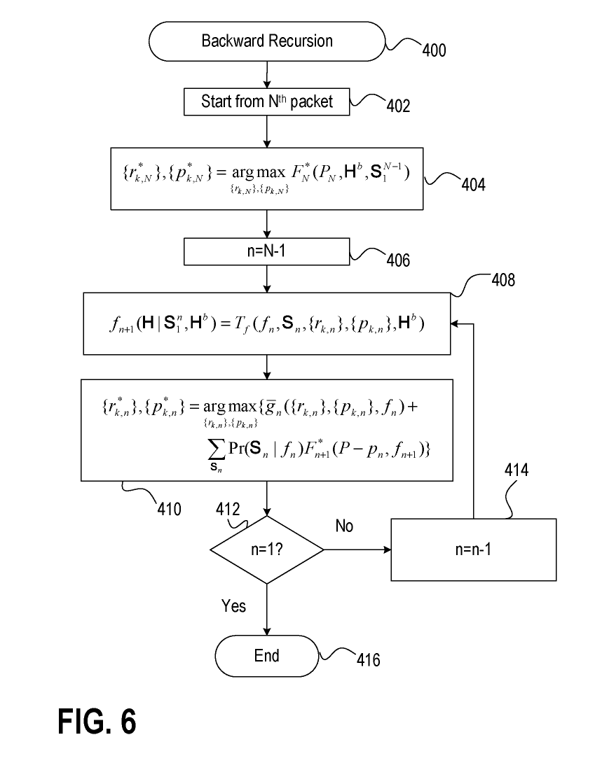

In FIG. 6, an offline backward recursive methodology 400 for a solution is elaborated in the following steps for an nth packet (block 402).

Step 1, depicted in block 404. For n=N, the optimal rate and power allocations {p_{k,N}*,r_{k,N}*} are given by:

$$\begin{matrix}\begin{matrix}\{ {r}_{k , N}^{*} ( {S}_{1}^{N - 1} ) \} , \{ {p}_{k , N}^{*} ( {S}_{1}^{N - 1} ) \} = arg {max}_{\{ {r}_{k , N} \} , \{ {p}_{k , N} \}} {F}_{N}^{*} ( {P}_{N} , {H}^{b} , {S}_{1}^{N - 1} ) \\ = arg {max}_{\{ {r}_{k , N} \} , \{ {p}_{k , N} \}} {\overline{g}}_{N} ( \{ {p}_{k , N} \} , \{ {r}_{k , N} \} , {H}^{b} , {S}_{1}^{N - 1} ) \\ = arg {max}_{\{ {r}_{k , N} \} , \{ {p}_{k , N} \}} {\sum }_{k ∈ A} {r}_{k , N} \cdot \\ Pr ( {C}_{k , N} \geq {r}_{k , N} \vert {H}^{b} , {S}_{1}^{N - 1} )\end{matrix} \\ where \\ {p}_{N} = {\sum }_{k ∈ A} {p}_{k , N}\end{matrix} \qquad ( 14 )$$

Hence, F_{N}* can be expressed as a function of S₁^{N-1},H^{b} and P_{N}.

Step 2. The optimal rate and power allocations for n={N−1, N−2, . . . 1} (block 406). In fact, the knowledge of the ACK/NAK sequence up the the n-th packet burst, S₁ⁿ⁻¹, affects only the knowledge of the conditional probability density function (PDF) of the actual CSIR H before transmitting the n-th packet burst. Let fₙ(H|S₁ⁿ⁻¹,H^{b}) be the estimated conditional pdf of the actual CSI H before transmitting the n-th packet burst. Hence fₙ₊₁(H|S₁ⁿ,H^{b}), can be expressed recursively as a transformation in terms of fₙ(H|S₁ⁿ⁻¹,H^{b}) as below (block 408).

fₙ₊₁(H|S₁ⁿ,H^{b})=T_{f}(fₙ,Sₙ,{r_{k,n}},{p_{k,n}},H^{b}) (15)

Without loss of generality, the effects of knowing S₁ⁿ⁻¹ is equivalent to the knowledge of the estimated conditional density functions of the actual CSI, fₙ(H|S₁ⁿ⁻¹,H^{b}), during the n-th packet burst. Hence, recursively, for n={N−1, N−2, . . . 1}, in block 410 the optimal rate and power allocations {p_{k,n}*,r_{k,n}*} are given by:

$$\begin{matrix}\{ {r}_{k , n}^{*} ( {S}_{1}^{n - 1} ) \} , \{ {p}_{k , n}^{*} ( {S}_{1}^{n - 1} ) \} = arg {max}_{\{ {p}_{k , n} \} , \{ {r}_{k , n} \}} \{ \begin{matrix}{\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) {F}_{n + 1}^{*} ( P - {p}_{n} , {H}^{b} , {S}_{1}^{n} )\end{matrix} \} \\ = arg {max}_{\{ {p}_{k , n} \} , \{ {r}_{k , n} \}} \{ \begin{matrix}{\overline{g}}_{n} ( \{ {p}_{k , n} \} , \{ {r}_{k , n} \} , {f}_{n} ) + \\ {\sum }_{{S}_{n}} Pr ( {S}_{n} \vert {f}_{n} ) {F}_{n + 1}^{*} ( P - {p}_{n} , {f}_{n + 1} )\end{matrix} \} \\ = arg {max}_{\{ {p}_{k , n} \} , \{ {r}_{k , n} \}} \{ \begin{matrix}{\overline{g}}_{n} ( \{ {p}_{k , n} \} , \{ {r}_{k , n} \} , {f}_{n} ) + \\ {\sum }_{{S}_{n}} Pr ( {S}_{n} \vert {f}_{n} ) {F}_{n + 1}^{*} ( \begin{matrix}P - {p}_{n} , \\ {T}_{f} ( \begin{matrix}{f}_{n} , {S}_{n} , \{ {r}_{k , n} \} , \\ \{ {p}_{k , n} \} , {H}^{b}\end{matrix} )\end{matrix} )\end{matrix} \} \\ = arg {max}_{\{ {p}_{k , n} \} , \{ {r}_{k , n} \}} \{ \begin{matrix}{\sum }_{k ∈ A} {r}_{k , n} Pr ( {C}_{k , n} \geq {r}_{k , n} \vert {f}_{n} ) + \\ {\sum }_{{S}_{n}} Pr ( {S}_{n} \vert {f}_{n} ) {F}_{n + 1}^{*} ( \begin{matrix}P - {p}_{n} , \\ {T}_{f} ( \begin{matrix}{f}_{n} , {S}_{n} , \{ {r}_{k , n} \} , \\ \{ {p}_{k , n} \} , {H}^{b}\end{matrix} )\end{matrix} )\end{matrix} \}\end{matrix} \qquad ( 16 )$$

where the final equality is due to (15) and

$${p}_{n} = {\sum }_{k ∈ A} {p}_{k , n} .$$

with the loop begun in block 406 concluded in block 412 by a determination if n=1 is reached and in block 414 if not by decrementing the n index and if so exiting in block 416.

Hence, we can express Fₙ* as a function of S₁ⁿ⁻¹,H^{b} and P for n=N−1 to 1. Note that at each n, the optimal power and rate allocation policies are function of S₁ⁿ⁻¹ only and hence, they satisfy the causality constraint.

### 4.2. General Online Solution for the Rate and Power Adaptation.

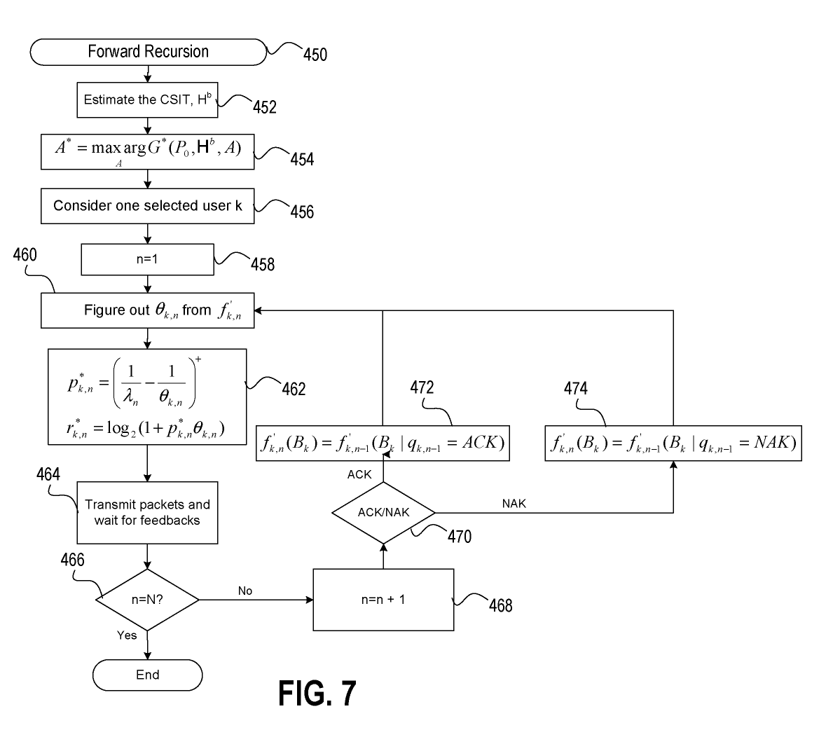

In the illustrative version of FIG. 7, the online strategy is a real-time forward methodology 450 (i.e., algorithm). For instance, before transmitting the n-th packet burst, we select the optimal power and rate allocation from the optimal policies {p_{k,n}*} and {r_{k,n}*} (obtained in the offline backward recursion methodology 400 of FIG. 6) upon receiving the specific ACK/NAK feedbacks S₁ⁿ⁻¹ from the mobile terminals 202.

Step 1. At the first packet burst, the optimal power and rate allocation {r_{k,1}*},{p_{k,1}*} based on the estimated CSIT H^{b} is obtained according to Eqn. (16) (block 452).

Step 2. Before transmitting the n-th packet burst (1=2,3, . . . N}), the base station has already obtained the specific ACK/NAK feedbacks of the previous n−1 packets S₁ⁿ⁻¹, as depicted in blocks. The optimal power and rate allocation for the n-th packet is obtained from {r_{k,n}*(S₁ⁿ⁻¹)},{p_{k,n}*(S₁ⁿ⁻¹)} according to Eqns. (16) and (14) in the offline recursion methodology 400 of FIG. 6.

### 4.3. Example: Closed-Form Solutions Based on a Simple Capacity Model.

It is clear that in order to solve the backward recursion, knowledge of the distribution of the channel capacity C_{k,n} is necessary. However, since its distribution relates to the statistics of the estimation error that is unknown to the base station, it is impossible to obtain the exact distribution of C_{k,n}. Due to the closed-loop nature of the ACK/NAK feedbacks, robustness is built into the closed-loop and we do not need to know the exact distribution of channel capacity C_{k,n}. Instead, we shall use a simple channel capacity model and rely on the ACK/NAK feedbacks to track the parameters of the capacity model. As more ACK/NAK feedbacks are obtained, the base station can learn and track the pdf of the CSI. We shall illustrate by simulation that although we do not know the exact distribution of the channel capacity, our simple channel capacity model works very well for slow fading channels (up to pedestrian mobility). The simple capacity model is elaborated below.

Model 1. A Simple Channel Capacity Model is

C_{k,n}=log₂(1+p_{k,n}Bₖ) (17)

where p_{k,n}Bₖ denotes the instantaneous signal to noise-plus-interference ratio (SINR) of the k-th user during the n-th packet burst. In addition, the model has the following properties:
Bₖ is quasi-static within a scheduling slot.
The conditional pdf of Bₖ is denoted by fₖ′(Bₖ|H^{b}). Given the ACK/NAK feedback sequence up to the n-th packet S₁ⁿ⁻¹, the estimated conditional pdf on Bₖ is denoted by f_{k,n}′(Bₖ|H^{b},S₁ⁿ⁻¹).

Using simple probability identities, we have the density evolution of Bₖ given by the following lemma.
Lemma 2. Using the simple capacity model in Model 17, the density evolution in (15) for Bₖ is given by:

$${f}_{k , n + 1}^{′} ( {B}_{k} \vert {H}^{b} , {S}_{1}^{n} ) = \{ \begin{matrix}\frac{{f}_{k , n}^{′} ( {B}_{k} \vert {H}^{b} , {S}_{1}^{n - 1} )}{Pr ( \frac{{2}^{{r}_{k , n}} - 1}{{p}_{k , n}} \leq {B}_{k} \vert {H}^{b} , {S}_{1}^{n - 1} )} & if {q}_{k , n} = 1 and {B}_{k} \geq \frac{{2}^{{r}_{k , n} - 1}}{{p}_{k , n}} \\ 0 & if {q}_{k , n} = 1 and {B}_{k} < \frac{{2}^{{r}_{k , n}} - 1}{{p}_{k , n}} or {q}_{k , n} = 0 and {B}_{k} > \frac{{2}^{{r}_{k , n}} - 1}{{p}_{k , n}} , \\ \frac{{f}_{k , n}^{′} ( {B}_{k} \vert {H}^{b} , {S}_{1}^{n - 1} )}{Pr ( {B}_{k} \leq \frac{{2}^{{r}_{k , n}} - 1}{{p}_{k , n}} \vert {H}^{b} , {S}_{1}^{n - 1} )} & if {q}_{k , n} = 0 and {B}_{k} \leq \frac{{2}^{{r}_{k , n} - 1}}{{p}_{k , n}}\end{matrix} \qquad ( 18 )$$

Proof for Lemma 2 is given below.

The closed-form solution for the offline backward recursion (described in subsection 1) is elaborated below.

Closed-Form Backward Recursion
Step 1:

$$\begin{matrix}{\overline{g}}_{N} ( {p}_{N} , \{ {f}_{k , n}^{′} \} ) = {\sum }_{k ∈ A} {r}_{k , N} Pr ( {C}_{k , N} \geq {r}_{k , N} \vert \{ {f}_{k , N}^{′} \} ) \\ = {\sum }_{k ∈ A} {r}_{k , N} ( 1 - ɛ )\end{matrix} \qquad ( 19 )$$

where ε is the target packet outage probability. To satisfy the target outage, the scheduled data rate policy {r_{k,N}*} is given by:

r_{k,N}*=log₂(1+p_{k,N}θ_{k,N}) (20)

where θ_{k,N} is the scaling factor is given by the root of the following equation (when n=N):

Pr[Bₖ≧θ_{k,n}|f_{k,n}′]=1−ε (21)

Let Φ_{k,n} be the corresponding CDF of the distribution f_{k,n}′, the general solution of (21) is given by:

θ_{k,n}=Φ_{k,n}⁻¹(ε) (22)

used in block 460 of FIG. 7. To determine the optimal power allocation policies, {p_{k,N}*}, we form the Lagrangian function as:

$$L = {\sum }_{k ∈ A} ( 1 - ɛ ) {log}_{2} ( 1 + {p}_{k , N} {θ}_{k , N} ) - \frac{1 - ɛ}{{λ}_{N} ln 2} {\sum }_{k ∈ A} {p}_{k , N} \qquad ( 23 )$$

Using standard approach, the optimal power allocation policy is given by:

$${p}_{k , N}^{*} = {( \frac{1}{{λ}_{N}} - \frac{1}{{θ}_{k , N}} )}^{+} \qquad ( 24 )$$

where (X)⁺=max{0,X} and λ_{N} is the Lagrangian multiplier given by

$$\frac{1}{{λ}_{N}} = \frac{1}{\vert A \vert} ( {p}_{N} + {\sum }_{k ∈ A} \frac{1}{{θ}_{k , N}} ) \qquad ( 25 )$$

for sufficiently large P₀. Hence, the closed-form for F_{N}* is given by:

$$\begin{matrix}{F}_{N}^{*} ( {p}_{N} , {f}_{k , N}^{′} ) = {\overline{g}}_{N}^{*} ( {p}_{N} , \{ {f}_{k , N}^{′} \} ) \\ = ( 1 - ɛ ) {{log}_{2} ( {p}_{N} + {\sum }_{k ∈ A} \frac{1}{{θ}_{k , N}} )}^{\vert A \vert} + \\ ( 1 - ɛ ) {log}_{2} ( \frac{{\prod }_{k ∈ A} {θ}_{k , N}}{{\vert A \vert}^{\vert A \vert}} )\end{matrix} \qquad ( 26 )$$

Step 2: Given a target outage probability ε, the probability Pr(Sₙ|{f_{k,n}′}) consists of a summation of the terms (1−ε)^{a}ε^{b}, where a is the total number of ACK feedbacks and b is the total number of NAK feedbacks in Sₙ. Since ε is usually chosen to be very small, most of the terms in Pr(Sₙ|{f_{k,n}′}) are very small except the one when a=|A| and b=0 (In this case, there is no transmission outage). Hence, we have:

$${F}_{n}^{*} ( P , \{ {f}_{k , N}^{′} \} ) = {max}_{\{ {p}_{k , N} \} , \{ {r}_{k , n} \}} \{ {\overline{g}}_{n} ( {p}_{n} , \{ {f}_{k , N}^{′} \} + {F}_{n + 1}^{*} ( P - {p}_{n} , \{ {f}_{k , n + 1}^{′} \} ) ) \} \qquad ( 27 )$$

Using the results in Step 1, the optimal power and rate allocation policies, {p_{k,n}*} and {r_{k,n}*} are given by:

$$\begin{matrix}{p}_{k , n}^{*} = {( \frac{1}{{λ}_{n}} - \frac{1}{{θ}_{k , n}} )}^{+} & ( 28 ) \\ {r}_{k , n}^{*} = {log}_{2} ( 1 + {p}_{k , n}^{*} {θ}_{k , n} ) \\ where & ( 29 ) \\ \frac{1}{{λ}_{n}} = \frac{1}{\vert A \vert} ( {p}_{n} + {\sum }_{k ∈ A} \frac{1}{{θ}_{k , n}} ) \\ and & ( 30 ) \\ {p}_{n} = \frac{P}{N - n + 1} + \frac{1}{N - n} {\sum }_{i = n}^{N} {\sum }_{k ∈ A} \frac{1}{{θ}_{k , i}} - {\sum }_{k ∈ A} \frac{1}{{θ}_{k , n}} & ( 31 )\end{matrix}$$

Similarly, we have

$$\begin{matrix}{F}_{n}^{*} ( P , \{ {f}_{k , n}^{′} \} ) = ( 1 - ɛ ) {{log}_{2} ( \frac{P}{N - n + 1} + \frac{{\sum }_{i = n}^{N} {\sum }_{k ∈ A} \frac{1}{{θ}_{k , i}}}{N - n + 1} )}^{( N - n + 1 ) \vert A \vert} + ( 1 - ɛ ) {log}_{2} ( \frac{{\prod }_{i = n}^{N} {\prod }_{k ∈ A} {θ}_{k , i}}{{\vert A \vert}^{( N - n + 1 ) \vert A \vert}} ) & \end{matrix} \qquad ( 32 )$$

### 4.4. Step II: Combinatorial Search on A.

The admitted user set A is determined at the start of the first packet burst (and fixed for the remaining packet bursts in a scheduling slot) based on the estimated CSIT only to optimize the conditional total goodput G*(•). The scheduler should calculate the conditional total goodput G*(•) of all possible user combinations, and choose the user combination with the maximum conditional total goodput G*(•) as the admitted user set. The optimal A is given by:

A*=maxarg_{A}G*(P₀,H^{b},A) (33)

as depicted at block 454 in FIG. 7. Alternatively, real-time genetic search can be used to simplify the search in (33). In the illustrative forward algorithm methodology 450, we use Model 1 as an example. Thus, block 456 considers one selected user k. An estimating loop begins at block 458 by initializing n=1. In block 460, the scaling factor θ_{k,N} is found based upon the CDF of the distribution f_{k,n}′ of Eqn. 22, based on previously measured ACK/NAK successful packet transmissions. In particular, in block 462, Eqns. 28, 29 is used for optimal power and rate allocation policies. In block 464, packets are transmitted and feedback is waited for. The loop concludes in block 466 with a determination of what the index n=N, and if so the loop exits. If not, the index is incremented in block 468. A determination is made in block 470 as to whether an ACK/NAK feedback was detected. If an ACK, then an evaluation is made in block 472 for f′_{k,n}(Bₖ|q_{k,n-1}=ACK). If a NAK, then an evaluation is made in block 474 for f′_{k,n}(Bₖ|q_{k,n-1}=NAK). After either block 472 or 474, processing returns to block 460.

### 5. Numerical Result and Discussion

In this section, we shall illustrate the performance of the closed-loop scheduler designs. In our simulation, the total number of receivers in the system K is 10. The duration of the packet slot is 0.2 ms. The Doppler frequency f_{d} is 1 and 10 Hz. Furthermore, the target packet outage probability is fixed to be ε=0.01. Each point in the figures is obtained by averaging over 1000 independent fading realizations. The estimated conditional density of Bₖ in the capacity model f_{k,n}′(Bₖ|H^{b},S₁ⁿ⁻¹) is assumed to be truncated Gaussian with parameters μ_{B}_{ₖ}(n) and σ_{B}_{ₖ}²(n) (mean and variance of the Gaussian part) as well as the lower and upper bounds on Bₖ (LBₖ(n), UBₖ(n)) respectively. From Lemma 18, the evolution of the density parameters given ACK/NAK feedbacks is given by:

$$\begin{matrix}{μ}_{{B}_{k}} ( n + 1 ) = {μ}_{{B}_{k}} ( n ) , {σ}_{{B}_{k}}^{2} ( n + 1 ) = {σ}_{{B}_{k}}^{2} ( n ) & \\ {LB}_{k} ( n + 1 ) = \{ \begin{matrix}max \{ {LB}_{k} ( n ) , \frac{{2}^{{r}_{k , n}} - 1}{{p}_{k , n}} \} & if {q}_{k , n} = 1 , \\ {LB}_{k} ( n ) & otherwise .\end{matrix} \\ and & ( 34 ) \\ {UB}_{k} ( n + 1 ) = \{ \begin{matrix}min \{ {UB}_{k} ( n ) , \frac{{2}^{{r}_{k , n}} - 1}{{p}_{k , n}} \} & if {q}_{k , n} = 0 , \\ {UB}_{k} ( n ) & otherwise .\end{matrix} & ( 35 )\end{matrix}$$

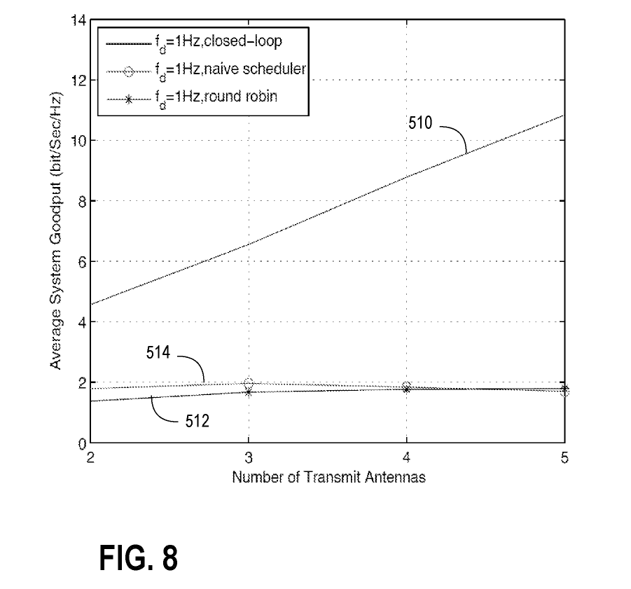

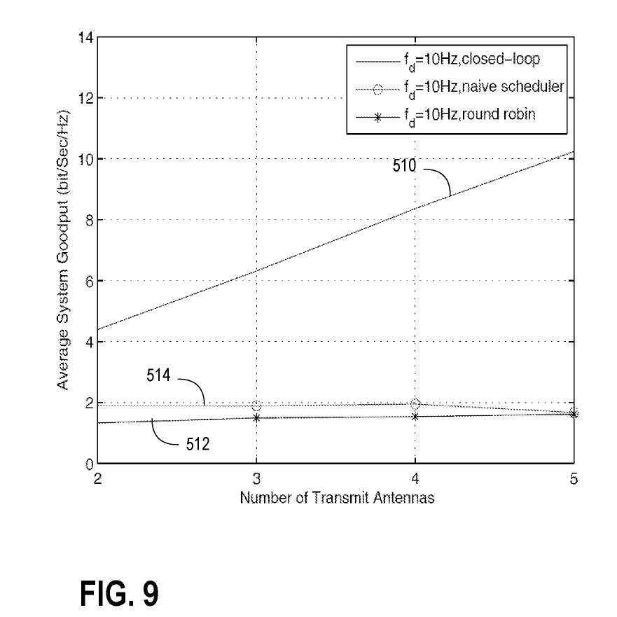

FIGS. 8-9 illustrate the average system goodput (bit/Sec/Hz) versus the number of transmit antennas n_{T} at various Doppler frequencies, CSIT error σ_{ΔH}²=0.1, SNR=23 dB and K=10 for Doppler frequencies f_{d}=1 Hz and 10 Hz, respectively. The duration of the scheduling slot is 4 ms. Observe that the system goodput increases significantly as n_{T} increases due to the spatial multiplexing gains. We also observe that there is a significant goodput gain of the proposed closed-loop scheduler, depicted at 510 in both figures, over the regular round robin scheduler, depicted at 512 in both figures. This illustrates the multi-user diversity gain and the proposed closed-loop scheduler offers robust and significant goodput gains at high CSIT errors and moderate Doppler frequency. Furthermore, there is also a significant goodput gain of the proposed closed-loop scheduler over the naive scheduler (scheduler designed for perfect CSIT and treats the estimated CSIT as the perfect CSIT), depicted at 514 in both figures.

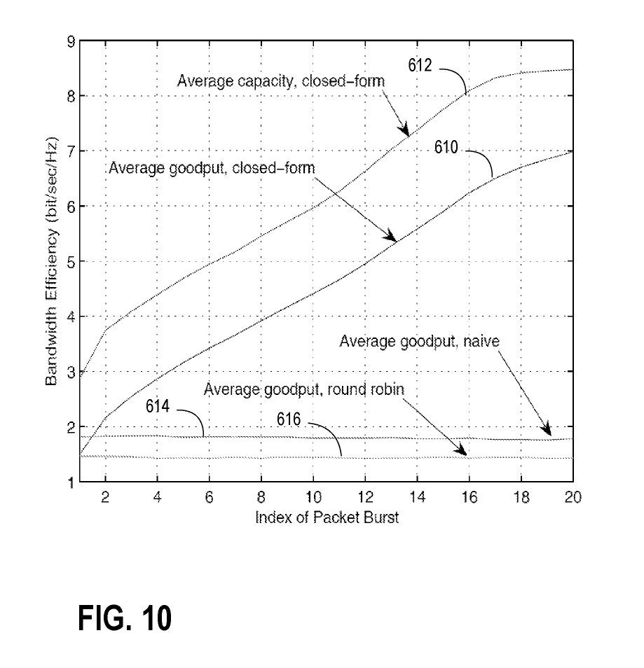

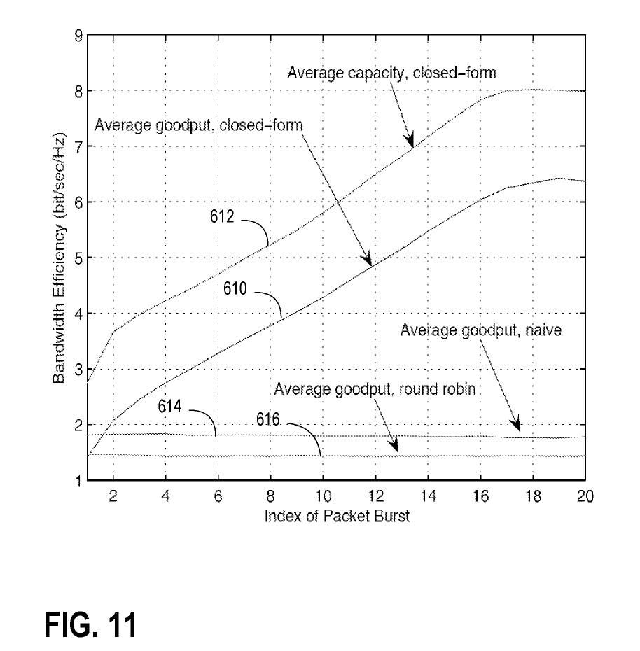

FIGS. 10-11 show the per-packet average goodput and the average capacity (i.e., averaged over 1000 channel realizations at the packet slot) at various Doppler frequencies for the proposed closed-loop scheduler depicted at 610 and 612 respectively as well as the round robin depicted at 614 and the naive scheduler depicted at 616 for Doppler frequency f_{d}=1 Hz and 10 Hz, respectively. The number of transmit antenna n_{T} is 2 and the total transmit power of a scheduling time slot is 23 dB. We observe that although there is about 1.5 bit/Sec/Hz performance degradation, which is due to the packet transmission outage and fact that the simple capacity model of Eqn. (17) is not the exact model, the goodput performance can still track the time variations of the instantaneous channel capacity even at high Doppler frequency f_{d}=10 Hz. We observe that both the average capacity and the average goodput increases as the index of packet increases. This is because the proposed scheduler tends to allow more power to the later packet slots because more information about the channel is obtained through ACK/NAK feedbacks.

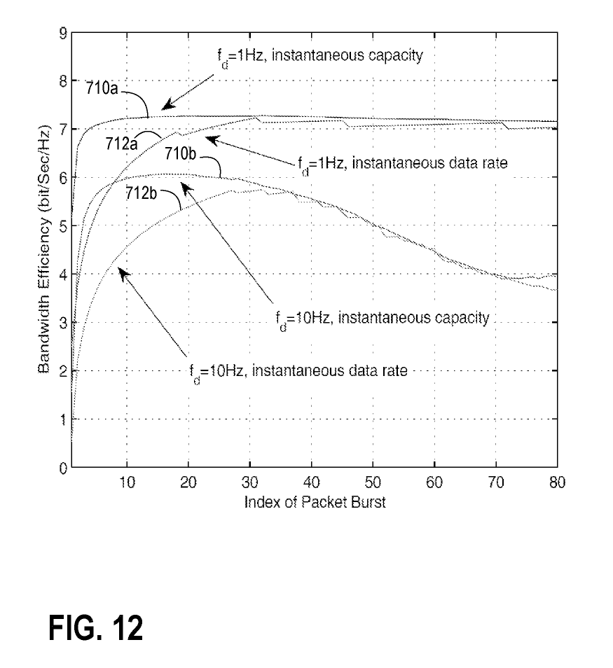

FIG. 12 shows the transient response of the loop. The instantaneous capacity depicted at 710a, 710b and the instantaneous scheduled rate depicted at 712a, 712b is plotted against the packet time slot at f_{d}=1 and f_{d}=10 Hz, respectively. In both cases, the scheduled data rate of the proposed closed-loop cross-layer design tracks the instantaneous capacity quite well. This justifies the robustness of our closed-loop scheduler with respect to the CSIT error, model mismatch and the channel variation due to Doppler.

PROOF OF LEMMA 1. Define Fₙ(P,H^{b},S₁ⁿ⁻¹) as:

$${F}_{n} ( P , {H}^{b} , {S}_{1}^{n - 1} ) = {\overline{g}}_{n} ( \{ {p}_{k , n} \} , \{ {r}_{k , n} \} , {H}^{b} , {S}_{1}^{n - 1} ) + {\sum }_{{S}_{n}} Pr ( {S}_{n} \vert {S}_{1}^{n - 1} , {H}^{b} ) {\overline{g}}_{n + 1} ( \{ {p}_{k , n} \} , \{ {r}_{k , n} \} , {H}^{b} , {S}_{1}^{n - 1} ) ++ {\sum }_{{S}_{n}^{N}} Pr ( {S}_{n}^{N} \vert {S}_{1}^{n - 1} , {H}^{b} ) {\overline{g}}_{N} ( \{ {p}_{k , n} \} , \{ {r}_{k , n} \} , {H}^{b} , {S}_{1}^{n - 1} ) \qquad ( 36 )$$

Hence, we have

$${F}_{n}^{*} ( P , {H}^{b} , {S}_{1}^{n - 1} ) = {max}_{\{ {p}_{k , n} , … , {p}_{k , N} \} , \{ {r}_{k , n} , … , {r}_{k , N} \}} {F}_{n} ( P , {H}^{b} , {S}_{1}^{n - 1} ) \qquad ( 37 )$$

Notice that

$$\begin{matrix}\begin{matrix}{F}_{n} ( P , {H}^{b} , {S}_{1}^{n - 1} ) = {\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) [ {\overline{g}}_{n + 1} {\overline{g}}_{n} ( \{ {p}_{k , n + 1} \} , \{ {r}_{k , n + 1} \} , {H}^{b} , {S}_{1}^{n} ) ++ \\ {\sum }_{{S}_{n}^{N}} Pr ( {S}_{n}^{N} \vert {S}_{1}^{n} , {H}^{b} ) {\overline{g}}_{N} ( \{ {p}_{k , N} \} , \{ {r}_{k , N} \} , {H}^{b} , {S}_{1}^{N - 1} ) ] \\ = {\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) {F}_{n + 1} ( P , {H}^{b} , {S}_{1}^{n - 1} )\end{matrix} \\ Hence , & ( 38 ) \\ \begin{matrix}{F}_{n}^{*} ( P , {H}^{b} , {S}_{1}^{n - 1} ) = {max}_{\{ {p}_{k , n} \} , \{ {r}_{k , n} \}} \{ {max}_{\{ {p}_{k , n + 1} , … , {p}_{k , N} \} , \{ {r}_{k , n + 1} , … , {r}_{k , N} \}} [ {\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) {F}_{n + 1} ( P - {p}_{n} , {H}^{b} , {S}_{1}^{n} ) ] \} \\ = {max}_{\{ {p}_{k , n} \} , \{ {r}_{k , n} \}} \{ {\overline{g}}_{n} ( \{ {p}_{k , n} \} , \{ {r}_{k , n} \} , {H}^{b} , {S}_{1}^{n - 1} ) + \\ {max}_{\{ {p}_{k , n + 1} , … , {p}_{k , N} \} , \{ {r}_{k , n + 1} , … , {r}_{k , N} \}} [ { \sum }_{{S}_{n}} Pr ( {S}_{n} \vert {S}_{1}^{n - 1} , {H}^{b} ) {F}_{n + 1} ( P , {H}^{b} , {S}_{1}^{n} ) ] \} \\ = {max}_{\{ {p}_{k , n} \} , \{ {r}_{k , n} \}} \{ {\overline{g}}_{n} ( \{ {p}_{k , n} \} , \{ {r}_{k , n} \} , {H}^{b} , {S}_{1}^{n - 1} ) + \\ {\sum }_{{S}_{n}} Pr ( {S}_{n} \vert {S}_{1}^{n - 1} , {H}^{b} ) {F}_{n + 1}^{*} ( P - {p}_{n} , {H}^{b} , {S}_{1}^{n} ) \}\end{matrix} & ( 39 )\end{matrix}$$

PROOF OF LEMMA 2. Consider a selected user k, given the density of Bₖ at the n-th packet burst, f_{k,n}′(Bₖ|H^{b},S₁ⁿ⁻¹). If an ACK is received after the n-th packet transmission, then we know that r_{k,n}≧log₂(1+p_{k,n}Bₖ), thus

$${B}_{k} \leq \frac{{2}^{{r}_{k , n} - 1}}{{p}_{k , n}} .$$

On the other hand, if a NAK is received, then we know that r_{k,n}≦log₂(1+p_{k,n}Bₖ), thus

$${B}_{k} \geq \frac{{2}^{{r}_{k , n} - 1}}{{p}_{k , n}} .$$

### Hence, we get Eqn. (18).

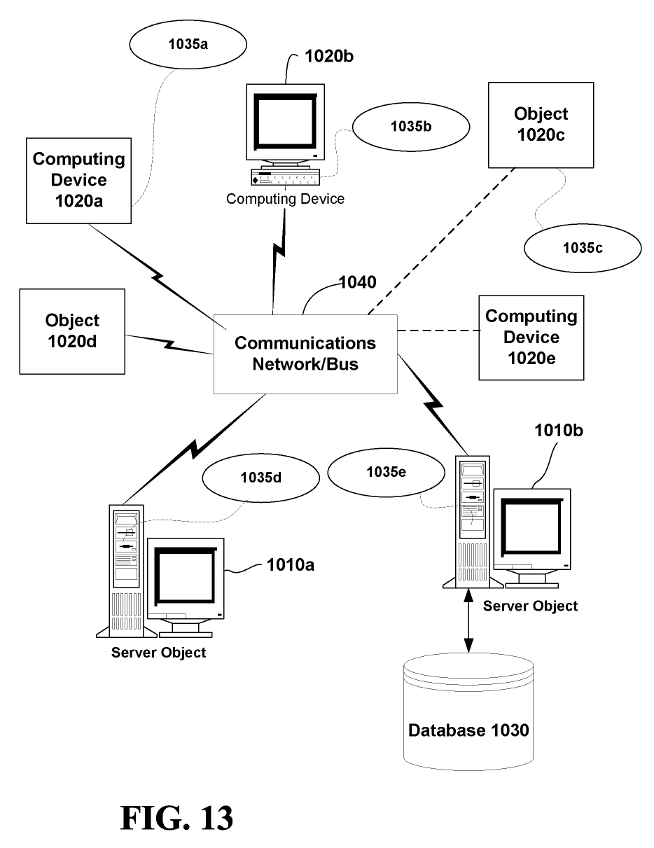

FIG. 13 provides a schematic diagram of an exemplary networked or distributed computing environment for implementing some or all of the afore-mentioned methodologies. The distributed computing environment comprises computing objects 1010a, 1010b, etc. and computing objects or devices 1020a, 1020b, 1020c, 1020d, 1020e, etc. These objects can comprise programs, methods, data stores, programmable logic, etc. The objects can comprise portions of the same or different devices such as PDAs, audio/video devices, MP3 players, personal computers, etc. Each object can communicate with another object by way of the communications network 1040. This network can itself comprise other computing objects and computing devices that provide services to the system of FIG. 13, and can itself represent multiple interconnected networks. In accordance with an aspect of at least one generalized non-limiting embodiment, each object 1010a, 1010b, etc. or 1020a, 1020b, 1020c, 1020d, 1020e, etc. can contain an application that might make use of an application programming interface (API), or other object, software, firmware and/or hardware, suitable for use with the design framework in accordance with at least one generalized non-limiting embodiment.

It can also be appreciated that an object, such as 1020c, can be hosted on another computing device 1010a, 1010b, etc. or 1020a, 1020b, 1020c, 1020d, 1020e, etc. Thus, although the physical environment depicted can show the connected devices as computers, such illustration is merely exemplary and the physical environment can alternatively be depicted or described comprising various digital devices such as PDAs, televisions, MP3 players, etc., any of which can employ a variety of wired and wireless services, software objects such as interfaces, COM objects, and the like.

There are a variety of systems, components, and network configurations that support distributed computing environments. For example, computing systems can be connected together by wired or wireless systems, by local networks or widely distributed networks. Currently, many of the networks are coupled to the Internet, which provides an infrastructure for widely distributed computing and encompasses many different networks. Any of the infrastructures can be used for exemplary communications made incident to optimization algorithms and processes according to the present innovation.

In home networking environments, there are at least four disparate network transport media that can each support a unique protocol, such as Power line, data (both wireless and wired), voice (e.g., telephone) and entertainment media. Most home control devices such as light switches and appliances can use power lines for connectivity. Data Services can enter the home as broadband (e.g., either DSL or Cable modem) and are accessible within the home using either wireless (e.g., HomeRF or 802.11A/B/G) or wired (e.g., Home PNA, Cat 5, Ethernet, even power line) connectivity. Voice traffic can enter the home either as wired (e.g., Cat 3) or wireless (e.g., cell phones) and can be distributed within the home using Cat 3 wiring. Entertainment media, or other graphical data, can enter the home either through satellite or cable and is typically distributed in the home using coaxial cable. IEEE 1394 and DVI are also digital interconnects for clusters of media devices. All of these network environments and others that can emerge, or already have emerged, as protocol standards can be interconnected to form a network, such as an intranet, that can be connected to the outside world by way of a wide area network, such as the Internet. In short, a variety of disparate sources exist for the storage and transmission of data, and consequently, any of the computing devices of the present innovation can share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g. a server. In the illustration of FIG. 13, as an example, computers 1020a, 1020b, 1020c, 1020d, 1020e, etc. can be thought of as clients and computers 1010a, 1010b, etc. can be thought of as servers where servers 1010a, 1010b, etc. maintain the data that is then replicated to client computers 1020a, 1020b, 1020c, 1020d, 1020e, etc., although any computer can be considered a client, a server, or both, depending on the circumstances. Any of these computing devices can be processing data or requesting services or tasks that can implicate the optimization algorithms and processes in accordance with at least one generalized non-limiting embodiment.

A server is typically a remote computer system accessible over a remote or local network, such as the Internet or wireless network infrastructures. The client process can be active in a first computer system, and the server process can be active in a second computer system, communicating with one another over a communications medium, thus providing distributed functionality and allowing multiple clients to take advantage of the information-gathering capabilities of the server. Any software objects utilized pursuant to the optimization algorithms and processes of at least one generalized non-limiting embodiment can be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g. client(s) and server(s) can be coupled to one another via TCP/IP connection(s) for high-capacity communication.

Thus, FIG. 13 illustrates an exemplary networked or distributed environment, with server(s) in communication with client computer (s) via a network/bus, in which the present innovation can be employed. In more detail, a number of servers 1010a, 1010b, etc. are interconnected via a communications network/bus 1040, which can be a LAN, WAN, intranet, GSM network, the Internet, etc., with a number of client or remote computing devices 1020a, 1020b, 1020c, 1020d, 1020e, etc., such as a portable computer, handheld computer, thin client, networked appliance, or other device, such as a VCR, TV, oven, light, heater and the like in accordance with the present innovation. It is thus contemplated that the present innovation can apply to any computing device in connection with which it is desirable to communicate data over a network.

In a network environment in which the communications network/bus 1040 is the Internet, for example, the servers 1010a, 1010b, etc. can be Web servers with which the clients 1020a, 1020b, 1020c, 1020d, 1020e, etc. communicate via any of a number of known protocols such as HTTP. Servers 1010a, 1010b, etc. can also serve as clients 1020a, 1020b, 1020c, 1020d, 1020e, etc., as can be characteristic of a distributed computing environment.

As mentioned, communications can be wired or wireless, or a combination, where appropriate. Client devices 1020a, 1020b, 1020c, 1020d, 1020e, etc. can or cannot communicate via communications network/bus 14, and can have independent communications associated therewith. For example, in the case of a TV or VCR, there can or cannot be a networked aspect to the control thereof. Each client computer 1020a, 1020b, 1020c, 1020d, 1020e, etc. and server computer 1010a, 1010b, etc. can be equipped with various application program modules or objects 1035a, 1035b, 1035c, etc. and with connections or access to various types of storage elements or objects, across which files or data streams can be stored or to which portion(s) of files or data streams can be downloaded, transmitted or migrated. Any one or more of computers 1010a, 1010b, 1020a, 1020b, 1020c, 1020d, 1020e, etc. can be responsible for the maintenance and updating of a database 1030 or other storage element, such as a database or memory 1030 for storing data processed or saved according to at least one generalized non-limiting embodiment. Thus, the present innovation can be utilized in a computer network environment having client computers 1020a, 1020b, 1020c, 1020d, 1020e, etc. that can access and interact with a computer network/bus 1040 and server computers 1010a, 1010b, etc. that can interact with client computers 1020a, 1020b, 1020c, 1020d, 1020e, etc. and other like devices, and databases 1030.

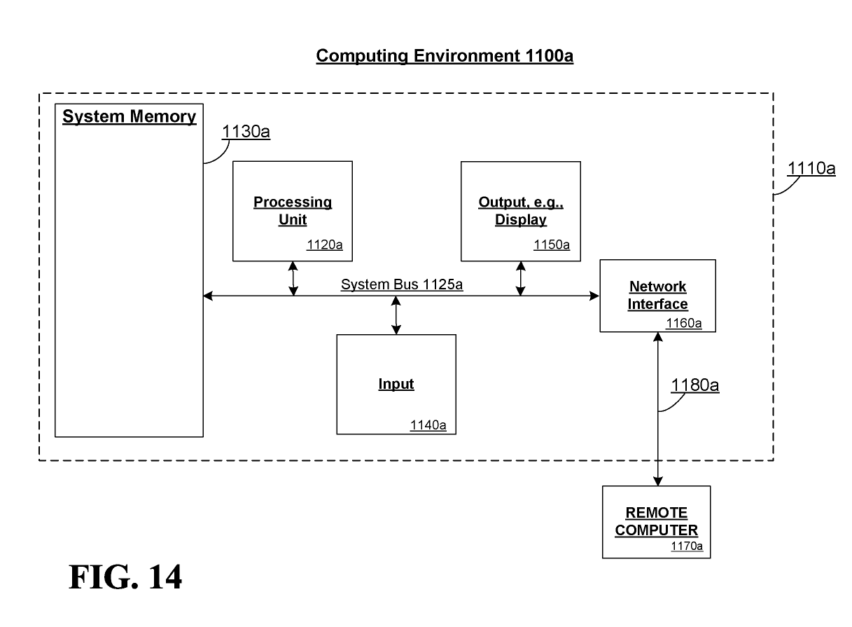

As mentioned, the innovation applies to any device wherein it can be desirable to communicate data, e.g. to a mobile device. It should be understood, therefore, that handheld, portable and other computing devices and computing objects of all kinds are contemplated for use in connection with the present innovation, i.e., anywhere that a device can communicate data or otherwise receive, process or store data. Accordingly, the below general purpose remote computer described below in FIG. 14 is but one example, and the present innovation can be implemented with any client having network/bus interoperability and interaction. Thus, the present innovation can be implemented in an environment of networked hosted services in which very little or minimal client resources are implicated, e.g. a networked environment in which the client device serves merely as an interface to the network/bus, such as an object placed in an appliance.

Although not required, at least one generalized non-limiting embodiment can partly be implemented via an operating system, for use by a developer of services for a device or object, and/or included within application software that operates in connection with the component(s) of at least one generalized non-limiting embodiment. Software can be described in the general context of computer executable instructions, such as program modules, being executed by one or more computers, such as client workstations, servers, or other devices. Those skilled in the art will appreciate that the innovation can be practiced with other computer system configurations and protocols.

FIG. 14 thus illustrates an example of a suitable computing system environment 1100a in which the innovation can be implemented, although as made clear above, the computing system environment 1100a is only one example of a suitable computing environment for a media device and is not intended to suggest any limitation as to the scope of use or functionality of the innovation. Neither should the computing environment 1100a be interpreted as having any dependency or requirement relating to any one or combination of components illustrated in the exemplary operating environment 1100a.

With reference to FIG. 14, an exemplary remote device for implementing at least one generalized non-limiting embodiment includes a general purpose computing device in the form of a computer 1110a. Components of computer 1110a can include, but are not limited to, a processing unit 1120a, a system memory 1130a, and a system bus 1125a that couples various system components including the system memory to the processing unit 1120a. The system bus 1125a can be any of several types of bus structures including a memory bus or memory controller, a peripheral bus, and a local bus using any of a variety of bus architectures.

Computer 1110a typically includes a variety of computer readable media. Computer readable media can be any available media that can be accessed by computer 1110a. By way of example, and not limitation, computer readable media can comprise computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 1110a. Communication media typically embodies computer readable instructions, data structures, program modules or other data in a modulated data signal such as a carrier wave or other transport mechanism and includes any information delivery media.

The system memory 1130a can include computer storage media in the form of volatile and/or non-volatile memory such as read only memory (ROM) and/or random access memory (RAM). A basic input/output system (BIOS), containing the basic routines that help to transfer information between elements within computer 1110a, such as during start-up, can be stored in memory 1130a. Memory 1130a typically also contains data and/or program modules that are immediately accessible to and/or presently being operated on by processing unit 1120a. By way of example, and not limitation, memory 1130a can also include an operating system, application programs, other program modules, and program data.

The computer 1110a can also include other removable/non-removable, volatile/non-volatile computer storage media. For example, computer 1110a could include a hard disk drive that reads from or writes to non-removable, non-volatile magnetic media, a magnetic disk drive that reads from or writes to a removable, non-volatile magnetic disk, and/or an optical disk drive that reads from or writes to a removable, non-volatile optical disk, such as a CD-ROM or other optical media. Other removable/non-removable, volatile/non-volatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 1125a through a non-removable memory interface such as an interface, and a magnetic disk drive or optical disk drive is typically connected to the system bus 1125a by a removable memory interface, such as an interface.

A user can enter commands and information into the computer 1110a through input devices such as a keyboard and pointing device, commonly referred to as a mouse, trackball or touch pad. Other input devices can include a microphone, joystick, game pad, satellite dish, scanner, or the like. These and other input devices are often connected to the processing unit 1120a through user input 1140a and associated interface(s) that are coupled to the system bus 1125a, but can be connected by other interface and bus structures, such as a parallel port, game port or a universal serial bus (USB). A graphics subsystem can also be connected to the system bus 1125a. A monitor or other type of display device is also connected to the system bus 1125a via an interface, such as output interface 1150a, which can in turn communicate with video memory. In addition to a monitor, computers can also include other peripheral output devices such as speakers and a printer, which can be connected through output interface 1150a.

The computer 1110a can operate in a networked or distributed environment using logical connections to one or more other remote computers, such as remote computer 1170a, which can in turn have media capabilities different from device 1110a. The remote computer 1170a can be a personal computer, a server, a router, a network PC, a peer device or other common network node, or any other remote media consumption or transmission device, and can include any or all of the elements described above relative to the computer 1110a. The logical connections depicted in FIG. 14 include a network 1180a, such local area network (LAN) or a wide area network (WAN), but can also include other networks/buses. Such networking environments are commonplace in homes, offices, enterprise-wide computer networks, intranets and the Internet.

When used in a LAN networking environment, the computer 1110a is connected to the LAN 1180a through a network interface or adapter. When used in a WAN networking environment, the computer 1110a typically includes a communications component, such as a modem, or other means for establishing communications over the WAN, such as the Internet. A communications component, such as a modem, which can be internal or external, can be connected to the system bus 1125a via the user input interface of input 1140a, or other appropriate mechanism. In a networked environment, program modules depicted relative to the computer 1110a, or portions thereof, can be stored in a remote memory storage device. It will be appreciated that the network connections shown and described are exemplary and other means of establishing a communications link between the computers can be used.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g. hard disk, floppy disk, magnetic strips . . . ), optical disks (e.g. compact disk (CD), digital versatile disk (DVD) . . . ), smart cards, and flash memory devices (e.g. card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g. a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” Furthermore, the term “or” as used in either the detailed description of the claims is meant to be a “non-exclusive or”.

Furthermore, as will be appreciated, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the methodology can infer or predict support or the degree of a flat fading channel based on previous interactions with the same or like machines under similar conditions.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for closed-loop downlink cross-layer scheduling in a multiple-input single output system, comprising:
measuring rate of acknowledgements and nonacknowledgements (ACK/NAK) from a mobile terminal in a slow fading channel;
estimating channel state information at transmitter (CSIT) based upon the measured rate of ACK/NAK; and
optimizing power and rate allocation on a downlink to the mobile terminal as a mixed combinatorial search and Markov decision process.

2. The method of claim 1, wherein the mobile terminal imparts a Doppler frequency shift relative to a transmitter of 5 km/hr or less.

3. The method of claim 1, further comprising:
solving the mixed combinatorial search and Markov decision process for a small target frame error rate (FER).

4. The method of claim 1, further comprising defining a recursive formulation of conditional goodput measure of bits per second per frequency measure transmitted to the mobile terminal as a Bellmen's equation.

5. The method of claim 1, further comprising measuring ACK/NAK feedback by employing a zero-forcing process.

6. The method of claim 1, further comprising receiving ACK/NAK feedback via a time division duplex uplink slot.

7. The method of claim 1, further comprising receiving ACK/NAK feedback via a frequency division duplex signal of not more than two bits length from the mobile terminal.

8. The method of claim 1, further comprising:
performing an offline recursion for a set of possible ACK/NAK feedback measures; and
performing an on-line strategy for a packet by selecting an offline recursion solution corresponding to a currently measured ACK/NAK measurement.

9. The method of claim 1, further comprising receiving ACK/NAK at a multiple antenna array that satisfies an uncorrelated antenna assumption at the base station.

10. An apparatus for closed-loop downlink cross-layer scheduling in a multiple-input single output system, comprising:
a receiver at a base station for measuring rate of acknowledgements and nonacknowledgements (ACK/NAK) from a mobile terminal in a slow fading channel;
a processor for estimating channel state information at transmitter (CSIT) based upon the measured rate of ACK/NAK; and
a scheduler for optimizing power and rate allocation on a downlink to the mobile terminal as a mixed combinatorial search and Markov decision process.

11. The apparatus of claim 10, wherein the receiver receives the ACK/NAK from the mobile terminal that imparts a Doppler frequency shift of 5 km/hr or less.

12. The apparatus of claim 10, further comprising an off-line recursive component for solving the mixed combinatorial search and Markov decision process for a small target frame error rate (FER).

13. The apparatus of claim 12, further comprising the off-line recursive component utilizing a recursive formulation for a conditional goodput measure of bits per second per frequency measure successfully transmitted to the mobile terminal as a Bellmen's equation.

14. The apparatus of claim 10, further comprising the processor measuring ACK/NAK feedback by employing a zero-forcing process.

15. The apparatus of claim 10, further comprising the receiver receiving ACK/NAK feedback via a time division duplex uplink slot.

16. The apparatus of claim 10, further comprising the receiver receiving ACK/NAK feedback via a frequency division duplex signal of not more than two bits length from the mobile terminal.

17. The apparatus of claim 10, further comprising:
an off-line recursive component performing an offline recursion for a set of possible ACK/NAK feedback measures; and
the processor performing an on-line strategy for a packet by selecting an offline recursion solution corresponding to a currently measured ACK/NAK measurement.

18. The apparatus of claim 10, further comprising a multiple antenna array that satisfies an uncorrelated antenna assumption at the base station for receiving the ACK/NAK feedback.

19. An apparatus for closed-loop downlink cross-layer scheduling in a multiple-input single output system, comprising:
means for measuring rate of acknowledgements and nonacknowledgements (ACK/NAK) from a mobile terminal in a slow fading channel;
means for estimating channel state information at transmitter (CSIT) based upon the measured rate of ACK/NAK; and
means for optimizing power and rate allocation on a downlink to the mobile terminal as a mixed combinatorial search and Markov decision process.

20. The apparatus of claim 19, wherein solving the mixed combinatorial search and Markov decision process is for a small target frame error rate (FER), further comprising:
means for utilizing a recursive formulation of conditional goodput measure of bits per second per frequency measure transmitted to the mobile terminal as a Bellmen's equation for optimizing power and rate allocation; and
means for measuring ACK/NAK feedback by employing a zero-forcing process.
